(19) United States
(12) Patent Application Publication
(10) Pub. No.: US 2026/0039184 A1
(43) Pub. Date: Feb. 5, 2026

(54) CONTROL METHOD FOR CASCADED SYSTEM AND CASCADED SYSTEM

(71) Applicant: Delta Electronics (Shanghai) Co.,Ltd., Shanghai (CN)

(72) Inventors: Hong LIU, Shanghai (CN); Wen ZHANG, Shanghai (CN); Yuxin HAN, Shanghai (CN); Sanyuan OUYANG, Shanghai (CN)

(21) Appl. No.: 19/274,657

(22) Filed: Jul. 21, 2025

(30) Foreign Application Priority Data
Aug. 5, 2024 (CN) 202411069578.2

(51) Int. Cl. H02M 1/00

(52) U.S. Cl. CPC H02M 1/007; H02M 1/0009; H02M 1/0025; H02M 1/0029; H02M 1/0043; H02M 1/0058

(57) ABSTRACT

The present application provides a control method for a cascaded system and a cascaded system, the cascaded system includes a first inductor and N power modules (N is an integer greater than or equal to 2), each of the power modules has a first side and a second side, the first sides of the N power modules and the first inductor are connected in series to form a branch which is subjected to a first voltage, the second side of each of the power modules is subjected to a second voltage. Each of the power modules includes a switch operating with a switching cycle. The number of power modules operating in a high-frequency modulation mode can be determined according to a ratio of the first voltage to the second voltage, so that there is a moment when a current flowing through the switch is zero within a single switching cycle.

### CROSS-REFERENCE TO RELATED APPLICATIONS

This application claims priority to Chinese Patent Application No. 202411069578.2, filed on Aug. 5, 2024 and entitled “CONTROL METHOD FOR CASCADED SYSTEM AND CASCADED SYSTEM”, which is hereby incorporated by reference in its entirety.

### TECHNICAL FIELD

The present application relates to the field of power electronics technology and, in particular, to a control method for a cascaded system and a cascaded system.

### BACKGROUND

In step-down applications, a modular cascaded architecture is commonly used, such as in solid-state transformers. Compared to traditional power frequency transformers, this approach leverages the high-frequency capabilities of power electronic devices, enabling higher power density, smaller size, and improved efficiency. The maximum switching frequency of the modules is typically limited by switching losses. A method to reduce switching losses is to operate the switching devices in a soft-switching mode, such as by employing ZVS (Zero Voltage Switching). In existing modular cascaded systems, the post-stage DC (direct current)-DC converter has achieved high-frequency operation through the implementation of soft-switching techniques. However, the pre-stage AC (alternating current)-DC converter still operates in hard switching mode, resulting in high switching losses, low frequency, and large filtering inductance, which has become an obstacle for further improving the power density of solid-state transformers.

At present, a single module AC-DC circuit usually operates in a TCM (Triangle Current Mode, triangle current mode) to achieve soft switching. For example, by adjusting the switching frequency, a current through the inductor is allowed to go to zero and then reverse, discharging a parasitic capacitor of the switch, thus meeting a ZVS turn-on condition of the switch. The AC-DC circuit in the cascaded system typically employs two modulation methods. One is carrier phase-shifting between modules, and the other is carrier stacking, that is, outputs of several modules maintain a logic level of 0 or 1, and only one module operates with high frequency.

However, in a cascaded system where carrier phase-shifting between modules is employed and TCM control is directly applied, the ripple cancellation resulting from carrier phase-shifting prevents ZVS from being achieved at duty cycles close to integer multiples of 1/N. If the carrier phase-shifting is abandoned in favor of synchronization among carriers of the cascaded modules, voltage across inductor will vary greatly, resulting in the necessity for a larger value of a filtering inductance, which in turn significantly weakens the effectiveness of TCM technology. If carrier stacking is used in the cascaded system and TCM technology is directly applied to modules performing high-frequency operations, any time a module is engaged or disengaged, changes of the duty cycle near 0 or 1 will also result in insufficient ripple to achieve ZVS.

### SUMMARY

The present application provides a control method for a cascaded system and a cascaded system, so as to offer a soft-switching solution for an AC-DC circuit in the cascaded system, thereby overcoming the deficiencies of directly applying TCM technology for single module to the cascaded system for soft-switching in prior art.

In a first aspect, the present application provides a control method for a cascaded system, the cascaded system includes a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules includes a switch, the switch operates with a switching cycle; the control method includes:
determining, according to a ratio of the first voltage to the second voltage, a number of power modules operating in a high-frequency modulation mode, so that there is a moment when a current flowing through the switch is zero within a single switching cycle.

In a possible design, the determining, according to the ratio of the first voltage to the second voltage, the number of the power modules operating in the high-frequency modulation mode, includes:
if the ratio is close to an integer, setting a duty cycle of each of the power modules according to the ratio, so that at least two power modules operate in the high-frequency modulation mode, and a duty cycle of a remaining power module is 0 or 1;
where a sum of duty cycles of the N power modules is the ratio.

In a possible design, a difference between the ratio and the integer is greater than −0.2 and less than 0.2.

In a possible design, each of the power modules includes an upper switch and a lower switch connected in series, controlling lower switches of the power modules operating in the high-frequency modulation mode to be simultaneously turned on but not simultaneously turned off.

In a possible design, each of the power modules includes two sub power modules and a second inductor, each of the sub power modules includes a bridge arm operating with power frequency and a bridge arm operating with high-frequency, the bridge arm operating with power frequency and the bridge arm operating with high-frequency of a same sub power module are connected in parallel, midpoints of bridge arms operating with power frequency of the two sub power modules are connected to the first side, and midpoints of bridge arms operating with high-frequency of the two sub power modules are connected through the second inductor.

In a possible design, the bridge arm operating with power frequency includes two active switches connected in series.

In a possible design, the bridge arm operating with power frequency includes two diodes connected in series.

In a possible design, each of the power modules includes a first sub power module, a second sub power module and multiple third inductors, the first sub power module and the second sub power module each include a bridge arm operating with power frequency and multiple bridge arms operating with high-frequency, midpoints of the bridge arms operating with power frequency of the first sub power module and the second sub power module are connected to the first side, and midpoints of the multiple bridge arms operating with high-frequency of the first sub power module are connected to midpoints of the multiple bridge arms operating with high-frequency of the second sub power module one by one through corresponding third inductors, where the multiple bridge arms operating with high-frequency of the first sub power module operate in an interleaved manner, and the multiple bridge arms operating with high-frequency of the second sub power module operate in an interleaved manner.

In a possible design, the cascaded system further includes N capacitors, the N capacitors are connected to the first side of the N power modules in parallel respectively.

In a possible design, the determining, according to the ratio of the first voltage to the second voltage, the number of the power modules operating in the high-frequency modulation mode, includes:
obtaining, according to the ratio, a modulation ratio during a current working cycle; and
determining, according to the modulation ratio during the current working cycle, a number of power modules operating in the high-frequency modulation mode during the current working cycle.

In a possible design, the obtaining, according to the ratio, the modulation ratio during the current working cycle, includes:
sampling a current flowing through the first inductor in a previous cycle, comparing an average value of the current flowing through the first inductor with a current reference value to get a comparison result, processing the comparison result using a regulator to get an intermediate value, and superimposing the intermediate value to the ratio to obtain the modulation ratio during the current working cycle.

In a possible design, each of the power modules includes an upper switch and a lower switch connected in series;
when (M_{integer}−bw1)<Mₜₒₜₐₗ<(M_{integer}+bw2), controlling two power modules to operate in the high-frequency modulation mode, controlling a duty cycle of an upper switch of one of the two power modules operating in the high-frequency modulation mode to be (1−bw1)+α*(Mₜₒₜₐₗ−M_{integer}+bw1), and a duty cycle of an upper switch of the other one of the two power modules operating in the high-frequency modulation mode to be (1−α)*(Mₜₒₜₐₗ−M_{integer}+bw1), and controlling duty cycles of upper switches of (M_{integer}−1) power modules other than the two power modules operating in the high-frequency modulation mode to be 1, and a duty cycle of an upper switch of a remaining power module to be 0;
when Mₜₒₜₐₗ<(M_{integer}−bw1) or Mₜₒₜₐₗ>(M_{integer}+bw2), controlling one power module to operate in the high-frequency modulation mode, controlling a duty cycle of an upper switch of the one power module operating in the high-frequency modulation mode to be (Mₜₒₜₐₗ−M_{integer}), and controlling duty cycles of upper switches of M_{integer} power modules other than the one power module operating in the high-frequency modulation mode to be 1, and a duty cycle of an upper switch of a remaining power module to be 0;
where Mₜₒₜₐₗ is the modulation ratio during the current working cycle, when rem(Mₜₒₜₐₗ)>(1−bw1), M_{integer}=int(Mₜₒₜₐₗ)+1, otherwise M_{integer}=int(Mₜₒₜₐₗ), where rem(Mₜₒₜₐₗ) is a decimal part of Mₜₒₜₐₗ, int(Mₜₒₜₐₗ) is an integer part of Mₜₒₜₐₗ, a=bw1/(bw2+bw1), bw1=bw2, and 0<bw1<0.2.

In a possible design, the N power modules include a first power module and a second power module, the first power module and the second power module each include an upper switch and a lower switch connected in series, where the first power module and the second power module operate in the high-frequency modulation mode, while a remaining power module operates in a non-high-frequency modulation mode, the control method further includes: estimating a duration for a next switching cycle according to a following formula:

$${t}_{{1}_{est}} ( n ) = {T}_{s} ( n - 1 ) * ( 1 - {D}_{s 21} )$$

$${t}_{{2}_{est}} ( n ) = {T}_{s} ( n - 1 ) * ( {D}_{S 21} - {D}_{s 11} )$$

$${t}_{{3}_{est}} ( n ) = \frac{{i}_{0} ( n ) + {k}_{{1}_{est}} * {t}_{1} ( n ) + {k}_{{2}_{est}} * {t}_{2} ( n ) + {I}_{s e t}}{{k}_{{3}_{est}}}$$

$${k}_{{1}_{est}} = \frac{{V}_{i n} ( n ) - ( {M}_{integer} ( n ) - 1 ) * {V}_{d c}}{{L}_{g}}$$

$${k}_{{2}_{est}} = \frac{- {M}_{integer} ( n ) * {V}_{d c}}{{L}_{g}}$$

$${k}_{{3}_{est}} = \frac{{V}_{i n} ( n ) - ( {M}_{integer} ( n ) + 1 ) * {V}_{d c}}{{L}_{g}}$$

$${T}_{s \_ est} ( n ) = {t}_{1 \_ est} ( n ) + {t}_{2 \_ est} ( n ) + {t}_{3 \_ est} ( n )$$

where t_{1_est}(n) is an estimated duration for a lower switch of the second power module being turned on during the current switching cycle, t_{2_est}(n) is an estimated duration for a lower switch of the first power module being turned on and the lower switch of the second power module being turned off during the current switching cycle, t_{3_est}(n) is an estimated duration for the lower switch of the first power module being turned off during the current switching cycle, Tₛ(n−1) is a duration for a previous switching cycle, Dₛ₂₁ is a duty cycle of an upper switch of the second power module, Dₛ₁₁ is a duty cycle of an upper switch of the first power module, i₀(n) is a sampled value of a minimum current flowing through the first inductor during the current switching cycle, Iₛₑₜ is an absolute value of a minimum current flowing through the first inductor that enables zero voltage conduction of the upper switches and the lower switches, k_{1_est} is a slope of the current flowing through the first inductor during t_{1_est}(n), k_{2_est} is a slope of the current flowing through the first inductor during t_{2_est}(n), K_{3_est} is a slope of the current flowing through the first inductor during t_{3_est}(n), Vᵢₙ(n) is a magnitude of the first voltage during the current switching cycle, V_{dc} is a magnitude of the second voltage, L_{g} is an inductance of the first inductor, and T_{s_est}(n) is an estimated duration for the current switching cycle.

In a possible design, the method further includes: limiting the estimated duration for the current switching cycle according to a preset highest frequency and a preset lowest frequency, to obtain a duration for the current switching cycle.

In a second aspect, the present application provides a cascaded system, including: a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules includes a switch, the switch operates with a switching cycle; and a control unit, configured to determine, according to a ratio of the first voltage to the second voltage, a number of power modules operating in a high-frequency modulation mode, so that there is a moment when a current flowing through the switch is zero within a single switching cycle.

In a possible design, the control unit is specifically configured to:
if the ratio is close to an integer, set a duty cycle of each of the power modules according to the ratio, so that at least two power modules operate in the high-frequency modulation mode, and a duty cycle of a remaining power module is 0 or 1;
where a sum of duty cycles of the N power modules is the ratio.

In a possible design, a difference between the ratio and the integer is greater than −0.2 and less than 0.2.

In a possible design, each of the power modules includes an upper switch and a lower switch connected in series; and the control unit is further configured to:
control lower switches of the power modules operating in the high-frequency modulation mode to be simultaneously turned on but not simultaneously turned off.

In a possible design, each of the power modules includes two sub power modules and a second inductor, each of the sub power modules includes a bridge arm operating with power frequency and a bridge arm operating with high-frequency, the bridge arm operating with power frequency and the bridge arm operating with high-frequency of a same sub power module are connected in parallel, midpoints of bridge arms operating with power frequency of the two sub power modules are connected to the first side, and midpoints of bridge arms operating with high-frequency of the two sub power modules are connected through the second inductor.

In a possible design, the bridge arm operating with power frequency includes two active switches connected in series.

In a possible design, the bridge arm operating with power frequency includes two diodes connected in series.

In a possible design, each of the power modules includes a first sub power module, a second sub power module and multiple third inductors, the first sub power module and the second sub power module each include a bridge arm operating with power frequency and multiple bridge arms operating with high-frequency, midpoints of the bridge arms operating with power frequency of the first sub power module and the second sub power module are connected to the first side, and midpoints of the multiple bridge arms operating with high-frequency of the first sub power module are connected to midpoints of the multiple bridge arms operating with high-frequency of the second sub power module one by one through corresponding third inductors, where the multiple bridge arms operating with high-frequency of the first sub power module operate in an interleaved manner, and the multiple bridge arms operating with high-frequency of the second sub power module operate in an interleaved manner.

In a possible design, the cascaded system further includes N capacitors, the N capacitors are connected to the first side of the N power modules in parallel respectively.

In a possible design, the control unit is further configured to:
obtain, according to the ratio, a modulation ratio during a current working cycle; and
determine, according to the modulation ratio during the current working cycle, a number of power modules operating in the high-frequency modulation mode during the current working cycle.

In a possible design, the control unit is further configured to:
sample a current flowing through the first inductor in a previous cycle, compare an average value of the current flowing through the first inductor with a current reference value to get a comparison result, process the comparison result using a regulator to get an intermediate value, and superimpose the intermediate value to the ratio to obtain the modulation ratio during the current working cycle.

In a possible design, each of the power modules includes an upper switch and a lower switch connected in series;
when (M_{integer}−bw1)<Mₜₒₜₐₗ<(M_{integer}+bw2), the control unit is configured to:
control two power modules to operate in the high-frequency modulation mode, control a duty cycle of an upper switch of one of the two power modules operating in the high-frequency modulation mode to be (1−bw1)+α*(Mₜₒₜₐₗ−M_{integer}+bw1), and a duty cycle of an upper switch of the other one of the two power modules operating in the high-frequency modulation mode to be (1−α)*(Mₜₒₜₐₗ−M_{integer}+bw1), and control duty cycles of upper switches of (M_{integer}−1) power modules other than the two power modules operating in the high-frequency modulation mode to be 1, and a duty cycle of an upper switch of a remaining power module to be 0;
when Mₜₒₜₐₗ<(M_{integer}−bw1) or Mₜₒₜₐₗ>(M_{integer}+bw2), the control unit is configured to:
control one power module to operate in the high-frequency modulation mode, control a duty cycle of an upper switch of the one power module operating in the high-frequency modulation mode to be (Mₜₒₜₐₗ−M_{integer}), and control duty cycles of upper switches of M_{integer} power modules other than the one power module operating in the high-frequency modulation mode to be 1, and a duty cycle of an upper switch of a remaining power module to be 0;
where Mₜₒₜₐₗ is the modulation ratio during the current working cycle, when rem(Mₜₒₜₐₗ)>(1−bw1), M_{integer}=int(Mₜₒₜₐₗ)+1, otherwise M_{integer}=int(Mₜₒₜₐₗ), where rem(Mₜₒₜₐₗ) is a decimal part of Mₜₒₜₐₗ, int(Mₜₒₜₐₗ) is an integer part of Mₜₒₜₐₗ, a=bw1/(bw2+bw1), bw1=bw2, and 0<bw1<0.2.

In a possible design, the N power modules include a first power module and a second power module, the first power module and the second power module each include an upper switch and a lower switch connected in series, where the first power module and the second power module operate in the high-frequency modulation mode, while a remaining power module operates in a non-high-frequency modulation mode, the control unit is further configured to: estimate a duration for a next switching cycle according to a following formula,

$${t}_{{1}_{est}} ( n ) = {T}_{s} ( n - 1 ) * ( 1 - {D}_{s 21} )$$

$${t}_{{2}_{est}} ( n ) = {T}_{s} ( n - 1 ) * ( {D}_{S 21} - {D}_{s 11} )$$

$${t}_{{3}_{est}} ( n ) = \frac{{i}_{0} ( n ) + {k}_{{1}_{est}} * {t}_{1} ( n ) + {k}_{{2}_{est}} * {t}_{2} ( n ) + {I}_{s e t}}{{k}_{{3}_{est}}}$$

$${k}_{{1}_{est}} = \frac{{V}_{i n} ( n ) - ( {M}_{integer} ( n ) - 1 ) * {V}_{d c}}{{L}_{g}}$$

$${k}_{{2}_{est}} = \frac{- {M}_{integer} ( n ) * {V}_{d c}}{{L}_{g}}$$

$${k}_{{3}_{est}} = \frac{{V}_{i n} ( n ) - ( {M}_{integer} ( n ) + 1 ) * {V}_{d c}}{{L}_{g}}$$

$${T}_{s \_ est} ( n ) = {t}_{1 \_ est} ( n ) + {t}_{2 \_ est} ( n ) + {t}_{3 \_ est} ( n )$$

where t_{1_est}(n) is an estimated duration for a lower switch of the second power module being turned on during the current switching cycle, t_{2_est}(n) is an estimated duration for a lower switch of the first power module being turned on and the lower switch of the second power module being turned off during the current switching cycle, t_{3_est}(n) is an estimated duration for the lower switch of the first power module being turned off during the current switching cycle, Tₛ(n−1) is a duration for a previous switching cycle, Dₛ₂₁ is a duty cycle of an upper switch of the second power module, Dₛ₁₁ is a duty cycle of an upper switch of the first power module, i₀(n) is a sampled value of a minimum current flowing through the first inductor during the current switching cycle, Iₛₑₜ is an absolute value of a minimum current flowing through the first inductor that enables zero voltage conduction of the upper switches and the lower switches, k_{1_est} is a slope of the current flowing through the first inductor during t_{1_est}(n), k_{2_est} is a slope of the current flowing through the first inductor during t_{2_est}(n), K_{3_est} is a slope of the current flowing through the first inductor during t_{3_est}(n), Vᵢₙ(n) is a magnitude of the first voltage during the current switching cycle, V_{dc} is a magnitude of the second voltage, L_{g} is an inductance of the first inductor, and T_{s_est}(n) is an estimated a duration for the current switching cycle.

In a possible design, the control unit is further configured to:
limit the estimated duration for the current switching cycle according to a preset highest frequency and a preset lowest frequency, to obtain a duration for the current switching cycle.

### BRIEF DESCRIPTION OF THE DRAWINGS

In order to more clearly describe the technical solution in embodiments of the present application or the related art, the following will briefly introduce the drawings that need to be used in the description of the embodiments or the related art. Apparently, the drawings in the following description are a part of embodiments of the present application. For the persons of ordinary skill in the art, other drawings can be obtained based on these drawings without paying creative labor.

FIG. 1 is a schematic structure diagram of a cascaded system provided in an embodiment of the present application.

FIG. 2 is a schematic structure diagram of another cascaded system provided in an embodiment of the present application.

FIG. 3 is a schematic diagram of a current of an inductor and a driving signal waveform of a switch in a cascaded system provided in an embodiment of the present application.

FIG. 4a and FIG. 4b are schematic diagrams of a simulation effect provided by an embodiment of the present application.

FIG. 5 is a schematic structure diagram of yet another cascaded system provided in an embodiment of the present application.

FIG. 6 is a schematic structure diagram of yet another cascaded system provided in an embodiment of the present application.

FIG. 7 is another schematic diagram of a current of an inductor and a driving signal waveform of a switch in a cascaded system provided in an embodiment of the present application.

FIG. 8 is a schematic diagram of another simulation effect provided by an embodiment of the present application.

FIG. 9 is a schematic structure diagram of yet another cascaded system provided in an embodiment of the present application.

FIG. 10 is a schematic flowchart of a control method for a cascaded system provided in an embodiment of the present application.

FIG. 11 is a schematic diagram of an implementation effect of a control method for a cascaded system provided in an embodiment of the present application.

FIG. 12 is a schematic diagram of another implementation effect of a control method for a cascaded system provided in an embodiment of the present application.

### DESCRIPTION OF EMBODIMENTS

Here, exemplary embodiments will be described in detail, with examples shown in the accompanying drawings. When referring to the accompanying drawings, unless otherwise indicated, the same numbers in different drawings represent the same or similar elements. The embodiments described in the following exemplary embodiments do not represent all embodiments consistent with the present application. On the contrary, they are only examples of methods and apparatus consistent with some aspects of the present application as described in the accompanying claims.

The terms “first”, “second”, “third”, “fourth”, etc. (if exist) in the specification and claims of the present application and the accompanying drawings are used to distinguish similar objects and do not necessarily describe a specific order or sequence. It should be understood that data used in this way can be interchanged in appropriate circumstances, so that the embodiments described herein can be implemented in order other than those illustrated or described herein. In addition, the terms “including”, “including”, as well as any variations thereof, are intended to cover non exclusive inclusion, for example, a process, a method, a system, a product, or an apparatus that includes a series of steps or units needs not to be limited to those steps or units clearly listed, but may include other steps or units that are not clearly listed or inherent to the process, method, product, or apparatus.

At present, a single module AC-DC circuit usually operates in a TCM to achieve soft switching. The AC-DC circuit in the cascaded system typically employs two modulation methods. One is carrier phase-shifting between modules and the other is carrier stacking, that is, outputs of several modules maintain a logic level of 0 or 1, and only one module operates with high frequency. However, for the former modulation method, if TCM technology is directly applied, the carrier phase-shifting causes ripple cancellation, preventing ZVS from being achieved at duty cycles close to integer multiples of 1/N. If the carrier phase-shifting is abandoned in favor of synchronization among carriers of the cascaded modules, voltage across the inductor will vary greatly, resulting in the necessity for a larger value of a filtering inductance, which will in turn significantly weakens the effectiveness of TCM technology. For the latter modulation method, if TCM technology is directly applied to modules performing high-frequency operations, any time a module is engaged or disengaged, changes of the duty cycle near 0 or 1 will also result in insufficient ripple to achieve ZVS.

Aiming at the above-mentioned problems in existing technology, the present application provides a control method for a cascaded system and a cascaded system. The inventive concept of the control method for the cascaded system provided in the present application is that the cascaded system includes a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules includes a switch, the switch operates with a switching cycle. The number of power modules operating in a high-frequency modulation mode is determined based on a ratio of the first voltage to the second voltage, so that there is a moment when a current flowing through the switch is zero within a single switching cycle. A soft switching solution is provided for an AC-DC circuit in a cascaded system, which can avoid the situation where ZVS cannot be achieved at duty cycle near 0 or 1 due to the fact that each time only one power module is engaged in a high-frequency modulation mode in the carrier stacking, and also avoid the situation where ZVS cannot be achieved due to the ripple cancellation in carrier phase-shifting.

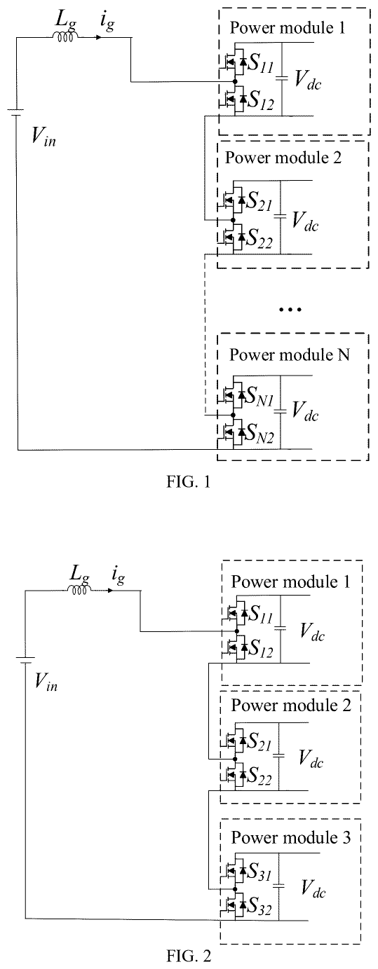

FIG. 1 is a schematic structure diagram of a cascaded system provided in an embodiment of the present application. As shown in FIG. 1, the cascaded system includes a first inductor L_{g} and N power modules, where N is an integer greater than or equal to 2. Among them, each of the power modules has a first side and a second side. The first sides of the N power modules and the first inductor L_{g} are connected in series to form a branch, the branch is subjected to a first voltage Vᵢₙ. The second side of each of the power modules is subjected to a second voltage V_{dc}. Each of the power modules includes a switch that operates with a switching cycle. The number of power modules operating in a high-frequency modulation mode is determined according to a ratio of the first voltage Vᵢₙ to the second voltage V_{dc} (the ratio M=Vᵢₙ/V_{dc}), so that there is a moment when a current i_{g} flowing through the switch is zero within a single switching cycle of the switch.

In some embodiments, if the ratio M is close to an integer, a duty cycle of each of the power modules may be set according to the ratio M, so that at least two power modules operate in the high-frequency modulation mode, and a duty cycle of a switch of other power module(s) is 0 or 1. Among them, a sum of duty cycles of switches of the N power modules is the ratio M=Vᵢₙ/V_{dc}=Σmᵢ, where mᵢ is the duty cycle of the switch of the i-th power module.

For example, when a value of M is close to an integer, such as M belonging to [n−0.1, n+0.1], where n is an integer, at least two power modules are engaged in the high-frequency modulation mode for each switching cycle, and a duty cycle of a switch of other power module(s) can remain unchanged at 0 or 1. For example, assuming N−6, if M=4.1, setting m₁=m₂=m₃=1, m₄+m₅=1.1, m6=0; if M=3.9, setting m₁=m₂=m₃=1, m₄+m₅=0.9, m₆=0. Among them, m₄ and m₅ are duty cycles of switches of the two power modules operating in the high-frequency modulation mode. Carriers of power modules operating in the high-frequency modulation mode are synchronized, and duty cycles may be the same or different.

In an implementation, the difference between the ratio M and the integer may be greater than −0.2 and less than 0.2.

It can be seen that the control method for a cascaded system provided in the embodiments of the present application differs from the carrier stacking modulation method in that it can avoid the situation where ZVS cannot be achieved at duty cycle near 0 or 1 due to the fact that each time only one power module is engaged in the high-frequency modulation mode in the carrier stacking; and differs from the carrier phase-shifting modulation method in that it can avoid the situation where ZVS cannot be achieved due to the ripple cancellation in carrier phase-shifting.

In some embodiments, each of the power modules includes an upper switch and a lower switch connected in series. The upper switch and the lower switch in each of the power modules are shown in FIG. 1 as, e.g., S₁₁ and S₁₂ in power module 1, S₂₁ and S₂₂ in power module 2, . . . , and S_{N1} and S_{N2} in power module N. The duty cycle of the switch in the module mentioned above refers to a duty cycle of the lower switch in the module. By controlling lower switches of respective power modules operating in the high-frequency modulation mode to simultaneously turn on, to achieve ZVS turn-on at the same time. However, in order to minimize a peak current, the power modules operating in the high-frequency modulation mode are not simultaneously turned off.

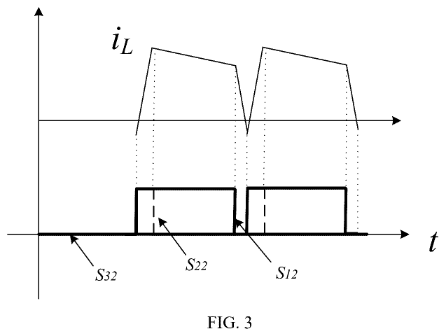

Taking cascaded Boost as an example, as shown in FIG. 2, FIG. 2 is a schematic structure diagram of another cascaded system provided in an embodiment of the present application. The cascaded system includes three power modules, that is, N=3. Assuming V_{dc}=1000V and Vᵢₙ=1900V, M=1.9, duty cycles of the lower switches of the power module 1 to power module 3 may be m₁=0.2, m₂=0.7, and m₃=1, respectively. That is to say, the lower switches S₁₂ and S₂₂ of the power module 1 and power module 2 are simultaneously turned on but not simultaneously turned off. The control of the switches may be achieved using the quadrilateral soft switching method shown in FIG. 3. Within one switching cycle, a waveform of a current i_{g} is quadrilateral. Thus, ZVS turn-on of the AC-DC switch can be achieved when an input voltage changes, reducing turn-on losses. Compared with the TCM technology, ripples in the input current are relatively lower, which can reduce turn-off losses and turn-on losses.

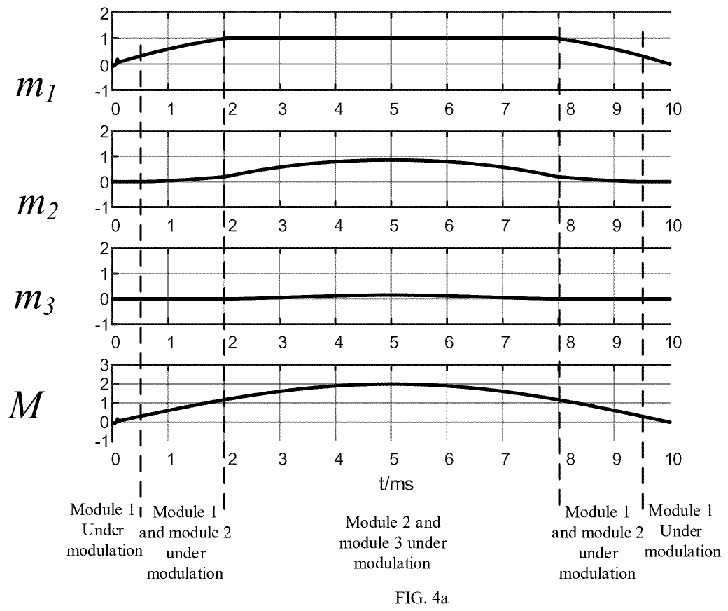

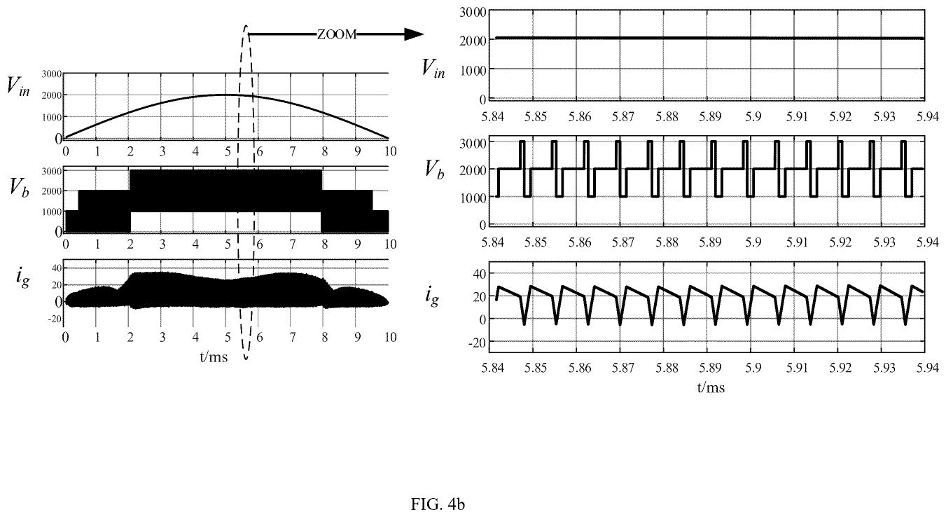

FIG. 4a and FIG. 4b are schematic diagrams of a simulation effect provided by an embodiment of the present application. Specifically, FIG. 4a and FIG. 4b are schematic diagrams of a simulation effect of the cascaded system shown in FIG. 3, where the simulation parameter Vᵢₙ is a rectified sinusoidal wave with a peak value of 1900V at a frequency of 50 hz, and V_{b} is the total bridge arm voltage of the cascaded system, V_{dc}=1000V. The module 1, module 2, and module 3 shown in FIG. 4a are respectively a power module 1, a power module 2, and a power module 3. From the simulations in FIG. 4a and FIG. 4b, it can be seen that the control method for a cascaded system provided in the embodiment of the present application can achieve ZVS of the switches in the cascaded system, and the current i_{g} exhibits a quadrilateral shape with small peaks.

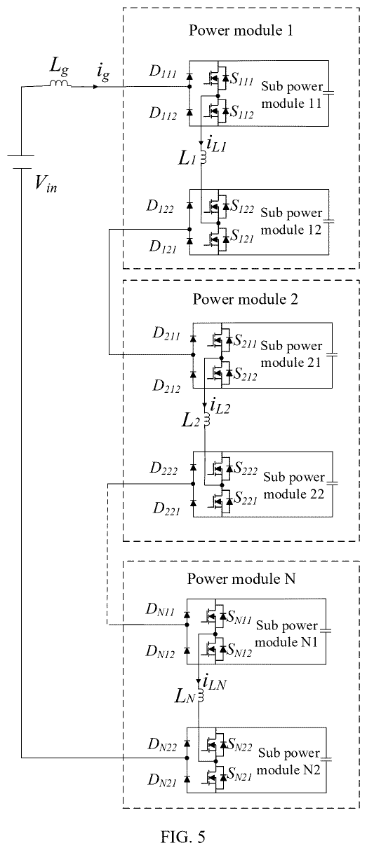

On the basis of FIG. 1, FIG. 5 is a schematic structure diagram of yet another cascaded system provided in an embodiment of the present application. As shown in FIG. 5, each of the power modules includes two sub power modules and a second inductor. For example, as shown in FIG. 5, the power module 1 includes a sub power module 11 and a sub power module 12, as well as a second inductor L₁, the power module 2 includes a sub power module 21 and a sub power module 22, as well as a second inductor L₂, the power module N includes a sub power module N₁ and a sub power module N₂, as well as a second inductor LN.

Each of the sub power modules includes a bridge arm operating with power frequency and a bridge arm operating with high-frequency, a bridge arm operating with power frequency and a bridge arm operating with high-frequency of a same sub power module are connected in parallel, midpoints of bridge arms operating with power frequency of the two sub power modules are connected to the first side of the module, and midpoints of bridge arms operating with high-frequency of the two sub power modules are connected through the second inductor.

The bridge arms operating with high-frequency of the two sub power modules included in each of the power modules may be equivalent to the two cascaded Boost modules as shown in FIG. 1. Therefore, the control method for a cascaded system provided in the embodiment of the present application can also be used to achieve ZVS, so as to achieve the same technical effect as FIG. 1.

In some embodiments, each of the bridge arms operating with power frequency may include two active switches connected in series, where the active switch is only a functional switch. In actual working conditions, multiple switches may be connected in series or in parallel to achieve the function of one switch here.

In some embodiments, each of the bridge arms operating with power frequency may include two diodes connected in series, for example, as shown in FIG. 5, a bridge arm operating with power frequency of a sub power module 11 of a power module 1 includes a diode Din and a diode D₁₁₂ connected in series, and a bridge arm operating with power frequency of a sub power module 12 of a power module 1 includes a diode D₁₂₁ and a diode D₁₂₂ connected in series.

Each of the bridge arms operating with power frequency including two active switches connected in series achieves ZVS turn-on. Each of the bridge arms operating with power frequency includes two diodes connected in series, which may operate in critical conduction mode, partially achieving ZVS.

It should be noted that the two diodes described above for each of the bridge arms operating with power frequency are only two functional diodes. In actual working conditions, multiple diodes may be connected in series or in parallel to achieve the function of one diode here. The two diodes shown for each of the bridge arms operating with power frequency in FIG. 5 are only exemplary rather than restrictive.

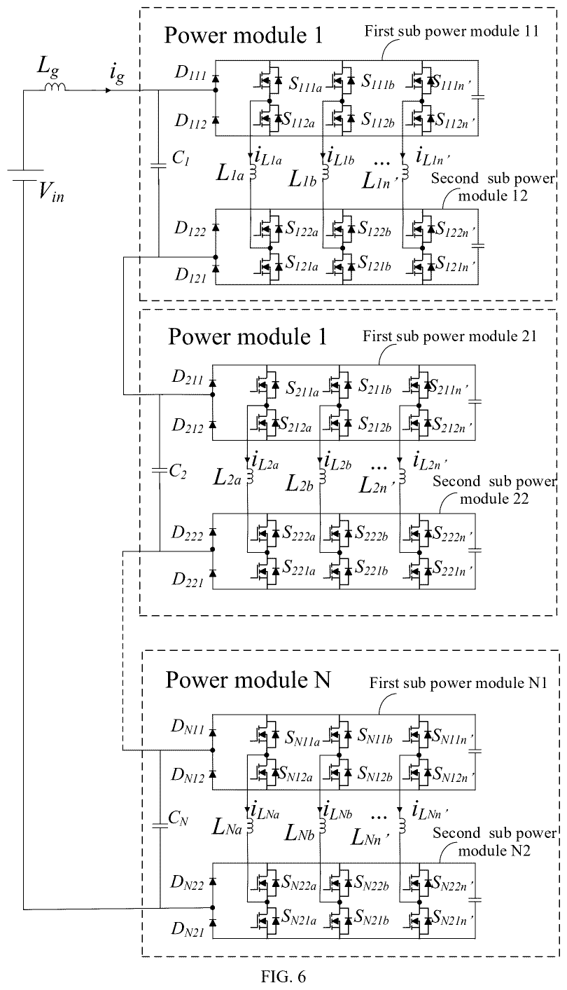

On the basis of FIG. 1, FIG. 6 is a schematic structure diagram of yet another cascaded system provided in an embodiment of the present application. As shown in FIG. 6, each power module (such as a power module 1 to a power module N) includes a first sub power module, a second sub power module, and multiple third inductors. For example, as shown in FIG. 6, the power module 1 includes a first sub power module 11, a second sub power module 12, and multiple third inductors (such as, L₁ₐ, L_{1b}, . . . , L_{in′}), the power module 2 includes a first sub power module 21, a second sub power module 22, and multiple third inductors (such as, L₂ₐ, L_{2b}, . . . , L_{2n′}), and the power module N includes a first sub power module N1, a second sub power module N2, and multiple third inductors (such as, L_{Na}, L_{Nb}, . . . , L_{Nn′}). In each of the power modules, the first sub power module and the second sub power module each include a bridge arm operating with power frequency and multiple bridge arms operating with high-frequency. Among them, midpoints of the bridge arms operating with power frequency of the first sub power module and the second sub power module in each of the power modules are connected to the first side of the power module, and midpoints of the multiple bridge arms operating with high-frequency of the first sub power module in each of the power modules are connected to midpoints of the multiple bridge arms operating with high-frequency of the second sub power module in the power module one by one through corresponding third inductors. For example, in the power module 1, midpoints of multiple bridge arms operating with high-frequency of the first sub power module 11 in power module 1 are connected to midpoints of multiple bridge arms operating with high-frequency of the second sub power module 12 in power module 1 through corresponding third inductors (L₁ₐ, L_{1b}, . . . , L_{1n′}).

The multiple bridge arms operating with high-frequency of the first sub power module in each of the power modules operate in an interleaved manner, and the multiple bridge arms operating with high-frequency of the second sub power module in each of the power modules operate in an interleaved manner. Each of the sub power modules has two or more bridge arms operating with high-frequency, the carrier phase-shifting between the bridge arms operating with high-frequency, phases of currents of the inductors are different, and the ripple of the total current is reduced. When the number of bridge arms operating with high-frequency is 2, the carriers of these two bridge arms are shifted by 180 degrees.

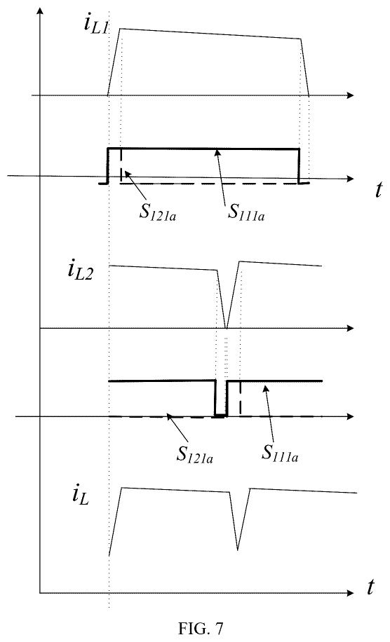

FIG. 7 is another schematic diagram of a current of an inductor and a driving signal waveform of a switch in a cascaded system provided in an embodiment of the present application. A control method for a cascaded system provided in an embodiment of the present application is applied to a cascaded system with a circuit including two bridge arms operating with high-frequency as shown in FIG. 6, the advantage is that all switches can achieve ZVS, and ripples of the bridge arms operating with high-frequency are cancelled, resulting in a reduction in the ripple of a total current. In an implementation, a diode included in the bridge arm operating with power frequency carries a power frequency current during unidirectional rectification operation, so a power frequency diode may be selected for cost saving. It should be noted that i_{L} in FIG. 7 represents a total current through multiple third inductors in the power module 1.

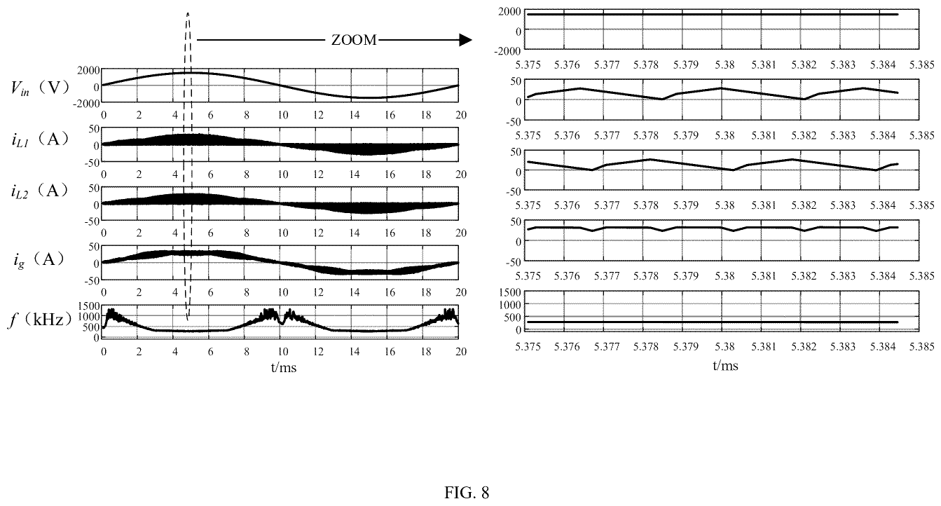

FIG. 8 is a schematic diagram of another simulation effect provided by an embodiment of the present application. Specifically, FIG. 8 shows a simulation corresponding to FIG. 7. Simulation parameters are V_{dc}=1000V, Vᵢₙ is a sine wave with an amplitude of 1500V, and L=40 uH. From the simulation results obtained in FIG. 8, it can be seen that the control method for a cascaded system provided in the embodiment of the present application can achieve ZVS of the switches of the cascaded system. The carrier phase-shifting between two sets of bridge arms operating with high-frequency results in different phases of ripples, so high-frequency ripple in synthesized total grid current is reduced, the simulation effect thereby verifies the implementation effect of FIG. 7.

Furthermore, the cascaded system shown in FIG. 6 may further include N capacitors, the N capacitors are connected to the first side of the N power modules in parallel respectively. The N capacitors are a capacitor C₁, a capacitor C₂ to a capacitor Cx as shown in FIG. 6. An input end of each of the power modules is connected to a capacitor, the capacitor may filter out a ripple of a high-frequency current to eliminate high-frequency component in the current. Furthermore, due to the stabilizing effect of the capacitor, the side voltages between power modules are independent from each other, allowing for decoupling of the control between modules.

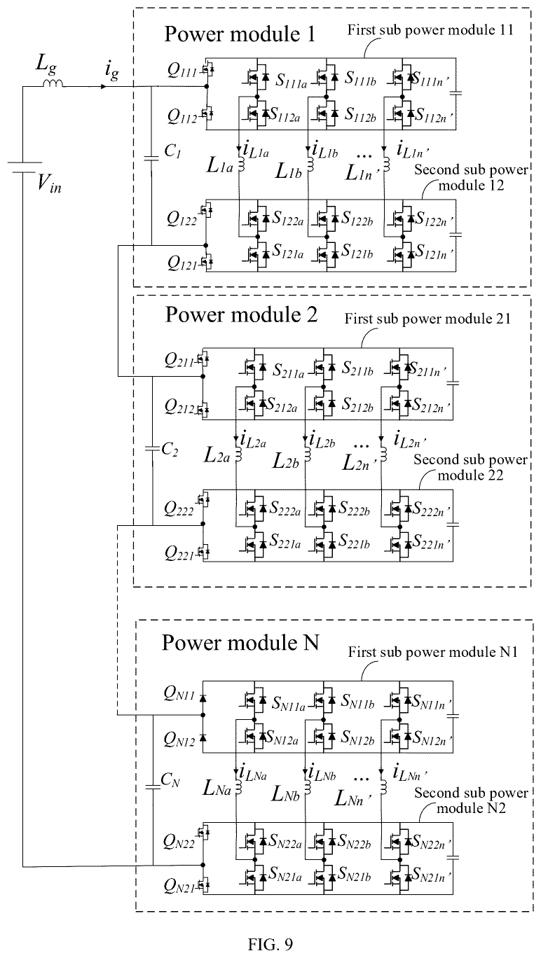

On the basis of FIG. 6, FIG. 9 is a schematic structure diagram of yet another cascaded system provided in an embodiment of the present application. The control method for a cascaded system provided in the embodiment of the present application is also applicable to a circuit of a cascaded system which can operate bidirectionally as shown in FIG. 9. As shown in FIG. 9, the circuit can operate in four quadrants, and the bridge arm operating with power frequency in each of the power modules may include switches operating with power frequency connected in series. For example, Q₁₁₁, Q₁₁₂, Q₁₂₁, and Q₁₂₂ in a power module 1 are switches operating with power frequency. In the power module 1, when a current is greater than zero, Qin and Q₁₂₁ are turned on, and when the current is less than zero, Q₁₁₂ and Q₁₂₂ are turned on.

In some embodiments, a low-cost Si MOSFET (metal-oxide-semiconductor field-effect transistor) and IGBT (insulated gate bipolar transistor) may be used as the switch operating with power frequency, while a SiC MOSFET or a GaN MOSFET may be used as the switch operating with high-frequency to maximize device capabilities.

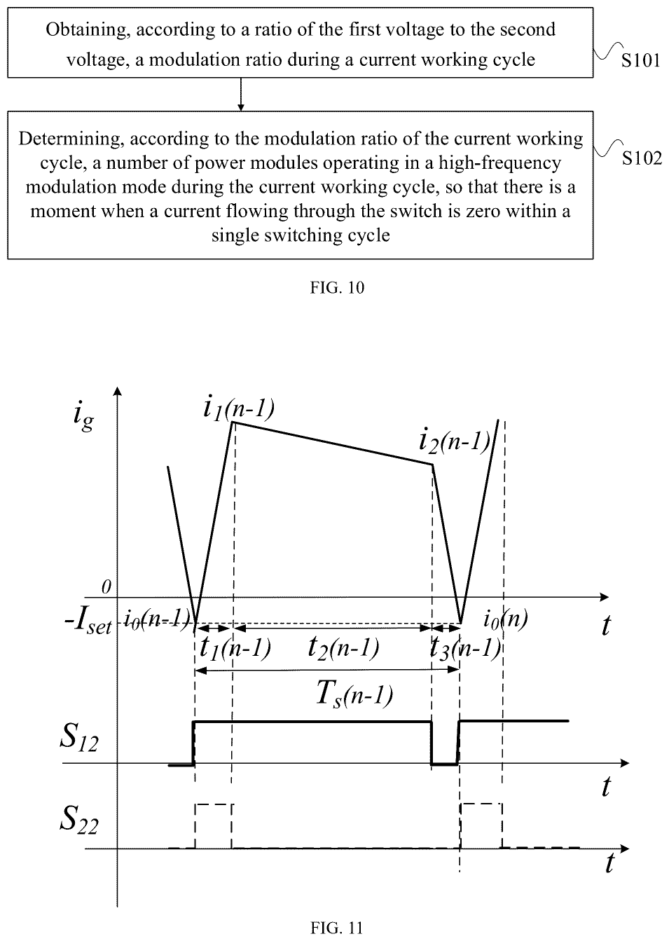

For the cascaded system provided in the above embodiments, FIG. 10 is a schematic flowchart of a control method for a cascaded system provided in an embodiment of the present application. As shown in FIG. 10, an embodiment of the present application include:

S101: obtaining, according to a ratio of the first voltage to the second voltage, a modulation ratio during a current working cycle.

Referring to the above cascaded system, the cascaded system includes a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules includes a switch, the switch operates with a switching cycle.

Sampling a current i_{g} flowing through the first inductor L_{g} in a previous cycle, comparing an average value i_{gmean} of the current i_{g} flowing through the first inductor with a current reference value i_{gRef} to get a comparison result. The comparison result is processed by a regulator to get an intermediate value and then the intermediate value is superimposed to the ratio M to obtain the modulation ratio Mₜₒₜₐₗ for the current working cycle.

In some embodiments, i_{gmean} may be obtained by sampling i_{g}, or may be obtained by direct sampling after i_{g} is subject to hardware filtering at a switching moment of the switch, or may be obtained based on calculation after i_{g} is sampled at a switching moment of the switch. For example, taking the cascaded system shown in FIG. 1 as an example, the following formula (1) can be obtained through an equal area method to obtain i_{gmean}.

$${T}_{s} * {I}_{g m e a n} ( n - 1 ) = \frac{1}{2} * ( {i}_{0} ( n - 1 ) + {i}_{1} ( n - 1 ) ) * {t}_{1} ( n - 1 ) + \frac{1}{2} * ( {i}_{1} ( n - 1 ) + {i}_{2} ( n - 1 ) ) * {t}_{2} + \frac{1}{2} * ( {i}_{2} ( n - 1 ) + {i}_{0} ( n ) ) * {t}_{3} ( n - 1 ) \qquad ( 1 )$$

Among them, as shown in FIGS. 11, t₁(n−1) is a duration when S12 and S22 were both turned on in a previous cycle, t₂(n−1) is a duration when S12 was turned on and S22 was turned off in the previous cycle, and t₃(n−1) is the a duration when S12 and S22 were both turned off in the previous cycle.

S102: determining, according to the modulation ratio during the current working cycle, the number of power modules operating in the high-frequency modulation mode during the current working cycle, so that there is a moment when a current flowing through the switch is zero within a single switching cycle.

As described in the previous embodiments, each of the power modules includes an upper switch and a lower switch connected in series.

As shown in the previous steps, the modulation ratio during the current working cycle Mₜₒₜₐₗ is obtained. When rem(Mₜₒₜₐₗ)>(1−bw1), M_{integer}−int(Mₜₒₜₐₗ)+1, that is, M_{integer} is a value rounded up from Mₜₒₜₐₗ; otherwise, M_{integer}=int(Mₜₒₜₐₗ), that is, M_{integer} is a value rounded down from Mₜₒₜₐₗ. Among them, rem(Mₜₒₜₐₗ) is a decimal part of Mₜₒₜₐₗ, int(Mₜₒₜₐₗ) is an integer part of Mₜₒₜₐₗ, a=bw1/(bw2+bw1), bw1=bw2, and 0<bw1<0.2.

For example, when (M_{integer}−bw1)<Mₜₒₜₐₗ<(M_{integer}+bw2), controlling two power modules to operate in the high-frequency modulation mode, controlling a duty cycle of an upper switch of one of the two power modules operating in the high-frequency modulation mode to be (1−bw1)+α*(Mₜₒₜₐₗ−M_{integer}+bw1), and a duty cycle of an upper switch of the other one of the two power modules operating in the high-frequency modulation mode to be (1−α)*(Mₜₒₜₐₗ−M_{integer}+bw1), and controlling duty cycles of upper switches of (M_{integer}−1) power modules other than the two power modules operating in the high-frequency modulation mode to be 1, and a duty cycle of an upper switch of a remaining power module to be 0.

When Mₜₒₜₐₗ<(M_{integer}−bw1) or Mₜₒₜₐₗ>(M_{integer}+bw2), controlling one power module to operate in the high-frequency modulation mode, controlling a duty cycle of an upper switch of the one power module operating in the high-frequency modulation mode to be (Mₜₒₜₐₗ−M_{integer}), and controlling duty cycles of upper switches of M_{integer} power modules other than the one power module operating in the high-frequency modulation mode to be 1, and a duty cycle of an upper switch of a remaining power module to be 0.

By using the above method, the number of power modules operating in the high-frequency modulation mode in the current working cycle can be determined according to the modulation ratio during the current working cycle, so that there is a moment when a current flowing through the switch is zero within a single switching cycle, which provides a soft switching solution for the AC-DC circuit in the cascaded system. Furthermore, it can avoid the situation where ZVS cannot be achieved at duty cycle near 0 or 1 due to the fact that each time only one power module is engaged in operating in the high-frequency modulation mode in the carrier stacking, and also avoid the situation where ZVS cannot be achieved due to the ripple cancellation in carrier phase-shifting.

Furthermore, for the cascaded system provided in the above embodiments, for example, the N power modules of the cascaded system include a first power module and a second power module, the first power module and the second power module each include an upper switch and a lower switch connected in series. If the first power module and the second power module operate in the high-frequency modulation mode and remaining power module(s) operates in a non-high-frequency modulation mode, the control method for the cascaded system provided in an embodiment of the present application further includes estimating a duration for a next switching cycle according to the following formulas (2)-(7):

$${t}_{{1}_{e s t}} ( n ) = {T}_{s} ( n - 1 ) * ( 1 - {D}_{s 21} ) \qquad ( 2 )$$

$${t}_{{2}_{e s t}} ( n ) = {T}_{s} ( n - 1 ) * ( {D}_{S 21} - {D}_{s 11} ) \qquad ( 3 )$$

$${t}_{{3}_{e s t}} ( n ) = \frac{{i}_{0} ( n ) + {k}_{{1}_{est}} * {t}_{1} ( n ) + {k}_{{2}_{est}} * {t}_{2} ( n ) + {I}_{s e t}}{{k}_{{3}_{e s t}}} \qquad ( 4 )$$

$${k}_{{1}_{e s t}} = \frac{{V}_{i n} ( n ) - ( {M}_{integer} ( n ) - 1 ) * {V}_{d c}}{{L}_{g}} \qquad ( 5 )$$

$${k}_{{2}_{e s t}} = \frac{- {M}_{integer} ( n ) * {V}_{d c}}{{L}_{g}} \qquad ( 6 )$$

$${k}_{{3}_{e s t}} = \frac{{V}_{i n} ( n ) - ( {M}_{integer} ( n ) + 1 ) * {V}_{d c}}{{L}_{g}} \qquad ( 7 )$$

$${T}_{s \_ est} ( n ) = {t}_{1 \_ est} ( n ) + {t}_{2 \_ est} ( n ) + {t}_{3 \_ est} ( n ) \qquad ( 8 )$$

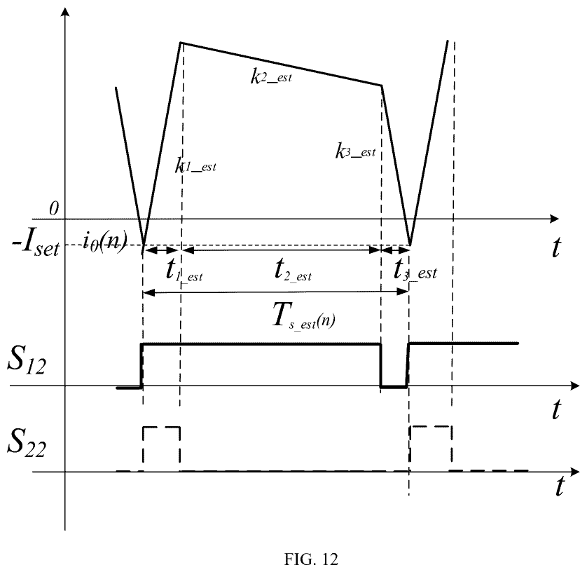

Among them, as shown in FIG. 12, t_{1_est}(n) is an estimated duration for a lower switch of the second power module being turned on during the current switching cycle, t_{2_est}(n) is an estimated duration for a lower switch of the first power module being turned on and the lower switch of the second power module being turned off during the current switching cycle, t_{3_est}(n) is an estimated duration for the lower switch of the first power module being turned off during the current switching cycle, Tₛ(n−1) is a duration for a previous switching cycle, Dₛ₂₁ is a duty cycle of an upper switch of the second power module, Dₛ₁₁ is a duty cycle of an upper switch of the first power module, i₀(n) is a sampled value of a minimum current flowing through the first inductor during the current switching cycle, Iₛₑₜ is an absolute value of a minimum current flowing through the first inductor that enables zero voltage conduction of the upper switches and the lower switches, k_{1_est} is a slope of the current flowing through the first inductor during t_{1_est}(n), k_{2_est} is a slope of the current flowing through the first inductor during t_{2_est}(n), k_{3_est} is a slope of the current flowing through the first inductor during t_{3_est}(n), Vᵢₙ(n) is a magnitude of the first voltage during the current switching cycle, V_{dc} is a magnitude of the second voltage, L_{g} is an inductance of the first inductor, and T_{s_est}(n) is an estimated duration for the current switching cycle.

In some embodiments, the estimated duration for the current switching cycle T_{s_est}(n) may further be limited according to a preset highest frequency and a preset lowest frequency of the cascaded system to obtain a duration for the current switching cycle Tₛ(n).

The present embodiment of the cascaded system further includes:
a control unit, configured to implement the control method for the cascaded system provided in the above embodiments, for example, determine, according to a ratio of the first voltage to the second voltage, the number of power modules operating in a high-frequency modulation mode, so that there is a moment when a current flowing through the switch is zero within a single switching cycle.

The person skilled in the art will easily come up with other embodiments of the present application after considering the specification and practicing the invention disclosed herein. The present application is intended to cover any variations, uses, or adaptive changes of the present application, which follow the general principles of the present application and include common knowledge or customary technical means in the art not disclosed in the present application. The specification and embodiments are only considered exemplary, and the true scope and spirit of the present application are indicated by the claims.

It should be understood that the present application is not limited to the precise structure described above and shown in the accompanying drawings, and various modifications and changes can be made without departing from its scope. The scope of the present application is limited only by the appended claims.

What is claimed is:

1. A control method for a cascaded system, wherein the cascaded system comprises a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules comprises a switch, the switch operates with a switching cycle; the control method comprises:
determining, according to a ratio of the first voltage to the second voltage, a number of power modules operating in a high-frequency modulation mode, whereby there is a moment when a current flowing through the switch is zero within a single switching cycle.

2. The control method according to claim 1, wherein the determining, according to the ratio of the first voltage to the second voltage, the number of the power modules operating in the high-frequency modulation mode, comprises:
if the ratio is close to an integer, setting a duty cycle of each of the power modules according to the ratio, whereby at least two power modules operate in the high-frequency modulation mode, and a duty cycle of a remaining power module is 0 or 1;
wherein a sum of duty cycles of the N power modules is the ratio.

3. The control method according to claim 2, wherein a difference between the ratio and the integer is greater than-0.2 and less than 0.2.

4. The control method according to claim 2, wherein each of the power modules comprises an upper switch and a lower switch connected in series, controlling lower switches of the power modules operating in the high-frequency modulation mode to be simultaneously turned on but not simultaneously turned off.

5. The control method according to claim 1, wherein each of the power modules comprises two sub power modules and a second inductor, each of the sub power modules comprises a bridge arm operating with power frequency and a bridge arm operating with high-frequency, the bridge arm operating with power frequency and the bridge arm operating with high-frequency of a same sub power module are connected in parallel, midpoints of bridge arms operating with power frequency of the two sub power modules are connected to the first side, and midpoints of bridge arms operating with high-frequency of the two sub power modules are connected through the second inductor.

6. The control method according to claim 5, wherein the bridge arm operating with power frequency comprises two active switches connected in series.

7. The control method according to claim 5, wherein the bridge arm operating with power frequency comprises two diodes connected in series.

8. The control method according to claim 1, wherein each of the power modules comprises a first sub power module, a second sub power module and multiple third inductors, the first sub power module and the second sub power module each comprise a bridge arm operating with power frequency and multiple bridge arms operating with high-frequency, midpoints of the bridge arms operating with power frequency of the first sub power module and the second sub power module are connected to the first side, and midpoints of the multiple bridge arms operating with high-frequency of the first sub power module are connected to midpoints of the multiple bridge arms operating with high-frequency of the second sub power module one by one through corresponding third inductors, wherein the multiple bridge arms operating with high-frequency of the first sub power module operate in an interleaved manner, and the multiple bridge arms operating with high-frequency of the second sub power module operate in an interleaved manner.

9. The control method according to claim 8, wherein the cascaded system further comprises N capacitors, the N capacitors are connected to the first side of the N power modules in parallel respectively.

10. The control method according to claim 1, wherein the determining, according to the ratio of the first voltage to the second voltage, the number of the power modules operating in the high-frequency modulation mode, comprises:
obtaining, according to the ratio, a modulation ratio during a current working cycle; and
determining, according to the modulation ratio during the current working cycle, a number of power modules operating in the high-frequency modulation mode during the current working cycle.

11. The control method according to claim 10, wherein the obtaining, according to the ratio, the modulation ratio during the current working cycle, comprises:
sampling a current flowing through the first inductor in a previous cycle, comparing an average value of the current flowing through the first inductor with a current reference value to get a comparison result, processing the comparison result using a regulator to get an intermediate value, and superimposing the intermediate value to the ratio to obtain the modulation ratio during the current working cycle.

12. The control method according to claim 10, wherein each of the power modules comprises an upper switch and a lower switch connected in series;
when (M_{integer}−bw1)<Mₜₒₜₐₗ<(M_{integer}+bw2), controlling two power modules to operate in the high-frequency modulation mode, controlling a duty cycle of an upper switch of one of the two power modules operating in the high-frequency modulation mode to be (1−bw1)+α*(Mₜₒₜₐₗ−M_{integer}+bw1), and a duty cycle of an upper switch of the other one of the two power modules operating in the high-frequency modulation mode to be (1−α)*(Mₜₒₜₐₗ−M_{integer}+bw1), and controlling duty cycles of upper switches of (M_{integer}−1) power modules other than the two power modules operating in the high-frequency modulation mode to be 1, and a duty cycle of an upper switch of a remaining power module to be 0;
when Mₜₒₜₐₗ<(M_{integer}−bw1) or Mₜₒₜₐₗ>(M_{integer}+bw2), controlling one power module to operate in the high-frequency modulation mode, controlling a duty cycle of an upper switch of the one power module operating in the high-frequency modulation mode to be (Mₜₒₜₐₗ−M_{integer}), and controlling duty cycles of upper switches of M_{integer} power modules other than the one power module operating in the high-frequency modulation mode to be 1, and a duty cycle of an upper switch of a remaining power module to be 0;
wherein Mₜₒₜₐₗ is the modulation ratio during the current working cycle, when rem(Mₜₒₜₐₗ)>(1−bw1), M_{integer}=int(Mₜₒₜₐₗ)+1, otherwise M_{integer} int(Mₜₒₜₐₗ), wherein rem(Mₜₒₜₐₗ) is a decimal part of Mₜₒₜₐₗ, int(Mₜₒₜₐₗ) is an integer part of Mₜₒₜₐₗ, a=bw1/(bw2+bw1), bw1=bw2, and 0<bw1<0.2.

13. The control method according to claim 10, wherein the N power modules comprise a first power module and a second power module, the first power module and the second power module each comprise an upper switch and a lower switch connected in series, wherein the first power module and the second power module operate in the high-frequency modulation mode, while a remaining power module operates in a non-high-frequency modulation mode, the control method further comprises: estimating a duration for a next switching cycle according to a following formula:
$${t}_{{1}_{e s t}} ( n ) = {T}_{s} ( n - 1 ) * ( 1 - {D}_{s 21} )$$
$${t}_{{2}_{e s t}} ( n ) = {T}_{s} ( n - 1 ) * ( {D}_{S 21} - {D}_{s 11} )$$
$${t}_{{3}_{e s t}} ( n ) = \frac{{i}_{0} ( n ) + {k}_{{1}_{est}} * {c}_{1} ( n ) + {k}_{{2}_{est}} * {c}_{2} ( n ) + {I}_{s e t}}{{k}_{{3}_{e s t}}}$$
$${k}_{{1}_{e s t}} = \frac{{V}_{i n} ( n ) - ( {M}_{i n t e g e r} ( n ) - 1 ) * {V}_{d c}}{{L}_{g}}$$
$${k}_{{2}_{e s t}} = \frac{- {M}_{i n t e g e r} ( n ) * {V}_{d c}}{{L}_{g}}$$
$${k}_{{3}_{e s t}} = \frac{{V}_{i n} ( n ) - ( {M}_{i n t e g e r} ( n ) + 1 ) * {V}_{d c}}{{L}_{g}}$$
$${T}_{s \_ est} ( n ) = {t}_{1 \_ est} ( n ) + {t}_{2 \_ est} ( n ) + {t}_{3 \_ est} ( n )$$
wherein t_{1_est}(n) is an estimated duration for a lower switch of the second power module being turned on during the current switching cycle, t_{2_est}(n) is an estimated duration for a lower switch of the first power module being turned on and the lower switch of the second power module being turned off during the current switching cycle, t_{3_est}(n) is an estimated duration for the lower switch of the first power module being turned off during the current switching cycle, Tₛ(n−1) is a duration for a previous switching cycle, Dₛ₂₁ is a duty cycle of an upper switch of the second power module, Dₛ₁₁ is a duty cycle of an upper switch of the first power module, i₀(n) is a sampled value of a minimum current flowing through the first inductor during the current switching cycle, Iₛₑₜ is an absolute value of a minimum current flowing through the first inductor that enables zero voltage conduction of the upper switches and the lower switches, k_{1_est} is a slope of the current flowing through the first inductor during t_{1_est}(n), k_{2_est} is a slope of the current flowing through the first inductor during t_{2_est}(n), K_{3_est} is a slope of the current flowing through the first inductor during t_{3_est}(n), Vᵢₙ(n) is a magnitude of the first voltage during the current switching cycle, V_{dc} is a magnitude of the second voltage, L_{g} is an inductance of the first inductor, and T_{s_est}(n) is an estimated duration for the current switching cycle.

14. The control method according to claim 13, further comprising: limiting the estimated duration for the current switching cycle according to a preset highest frequency and a preset lowest frequency, to obtain a duration for the current switching cycle.

15. A cascaded system, comprising: a first inductor and N power modules, N is an integer greater than or equal to 2, each of the power modules has a first side and a second side, the first sides of the N power modules and the first inductor are connected in series to form a branch, the branch is subjected to a first voltage, the second side of each of the power modules is subjected to a second voltage, and each of the power modules comprises a switch, the switch operates with a switching cycle; and
a control unit, configured to determine, according to a ratio of the first voltage to the second voltage, a number of power modules operating in a high-frequency modulation mode, whereby there is a moment when a current flowing through the switch is zero within a single switching cycle.

16. The cascaded system according to claim 15, wherein the control unit is specifically configured to:
if the ratio is close to an integer, set a duty cycle of each of the power modules according to the ratio, whereby at least two power modules operate in the high-frequency modulation mode, and a duty cycle of a remaining power module is 0 or 1;
wherein a sum of duty cycles of the N power modules is the ratio.

17. The cascaded system according to claim 16, wherein a difference between the ratio and the integer is greater than −0.2 and less than 0.2.

18. The cascaded system according to claim 16, wherein each of the power modules comprises an upper switch and a lower switch connected in series; and the control unit is further configured to:
control lower switches of the power modules operating in the high-frequency modulation mode to be simultaneously turned on but not simultaneously turned off.

19. The cascaded system according to claim 15, wherein each of the power modules comprises two sub power modules and a second inductor, each of the sub power modules comprises a bridge arm operating with power frequency and a bridge arm operating with high-frequency, the bridge arm operating with power frequency and the bridge arm operating with high-frequency of a same sub power module are connected in parallel, midpoints of bridge arms operating with power frequency of the two sub power modules are connected to the first side, and midpoints of bridge arms operating with high-frequency of the two sub power modules are connected through the second inductor.

20. The cascaded system according to claim 19, wherein the bridge arm operating with power frequency comprises two active switches connected in series.

21. The cascaded system according to claim 19, wherein the bridge arm operating with power frequency comprises two diodes connected in series.

22. The cascaded system according to claim 15, wherein each of the power modules comprises a first sub power module, a second sub power module and multiple third inductors, the first sub power module and the second sub power module each comprise a bridge arm operating with power frequency and multiple bridge arms operating with high-frequency, midpoints of the bridge arms operating with power frequency of the first sub power module and the second sub power module are connected to the first side, and midpoints of the multiple bridge arms operating with high-frequency of the first sub power module are connected to midpoints of the multiple bridge arms operating with high-frequency of the second sub power module one by one through corresponding third inductors, wherein the multiple bridge arms operating with high-frequency of the first sub power module operate in an interleaved manner, and the multiple bridge arms operating with high-frequency of the second sub power module operate in an interleaved manner.

23. The cascaded system according to claim 22, further comprising N capacitors, the N capacitors are connected to the first side of the N power modules in parallel respectively.

24. The cascaded system according to claim 15, wherein the control unit is further configured to:
obtain, according to the ratio, a modulation ratio during a current working cycle; and
determine, according to the modulation ratio during the current working cycle, a number of power modules operating in the high-frequency modulation mode during the current working cycle.

25. The cascaded system according to claim 24, wherein the control unit is further configured to:
sample a current flowing through the first inductor in a previous cycle, compare an average value of the current flowing through the first inductor with a current reference value to get a comparison result, process the comparison result using a regulator to get an intermediate value, and superimpose the intermediate value to the ratio to obtain the modulation ratio during the current working cycle.

26. The cascaded system according to claim 24, wherein each of the power modules comprises an upper switch and a lower switch connected in series;
when (M_{integer}−bw1)<Mₜₒₜₐₗ<(M_{integer}+bw2), the control unit is configured to:
control two power modules to operate in the high-frequency modulation mode, control a duty cycle of an upper switch of one of the two power modules operating in the high-frequency modulation mode to be (1−bw1)+α*(Mₜₒₜₐₗ−M_{integer}+bw1), and a duty cycle of an upper switch of the other one of the two power modules operating in the high-frequency modulation mode to be (1−α)*(Mₜₒₜₐₗ−M_{integer}+bw1), and control duty cycles of upper switches of (M_{integer}−1) power modules other than the two power modules operating in the high-frequency modulation mode to be 1, and a duty cycle of an upper switch of a remaining power module to be 0;
when Mₜₒₜₐₗ<(M_{integer}−bw1) or Mₜₒₜₐₗ>(M_{integer}+bw2), the control unit is configured to:
control one power module to operate in the high-frequency modulation mode, control a duty cycle of an upper switch of the one power module operating in the high-frequency modulation mode to be (Mₜₒₜₐₗ−M_{integer}), and control duty cycles of upper switches of M_{integer} power modules other than the one power module operating in the high-frequency modulation mode to be 1, and a duty cycle of an upper switch of a remaining power module to be 0;
wherein Mₜₒₜₐₗ is the modulation ratio during the current working cycle, when rem(Mₜₒₜₐₗ)>(1−bw1), M_{integer}=int(Mₜₒₜₐₗ)+1, otherwise M_{integer}=int(Mₜₒₜₐₗ), wherein rem(Mₜₒₜₐₗ) is a decimal part of Mₜₒₜₐₗ, int(Mₜₒₜₐₗ) is an integer part of Mₜₒₜₐₗ, a=bw1/(bw2+bw1), bw1=bw2, and 0<bw1<0.2.

27. The cascaded system according to claim 24, wherein the N power modules comprise a first power module and a second power module, the first power module and the second power module each comprise an upper switch and a lower switch connected in series, wherein the first power module and the second power module operate in the high-frequency modulation mode, while a remaining power module operates in a non-high-frequency modulation mode, the control unit is further configured to: estimate a duration for a next switching cycle according to a following formula:
$${t}_{{1}_{e s t}} ( n ) = {T}_{s} ( n - 1 ) * ( 1 - {D}_{s 21} )$$
$${t}_{{2}_{e s t}} ( n ) = {T}_{s} ( n - 1 ) * ( {D}_{S 21} - {D}_{s 11} )$$
$${t}_{{3}_{e s t}} ( n ) = \frac{{i}_{0} ( n ) + {k}_{{1}_{est}} * {c}_{1} ( n ) + {k}_{{2}_{est}} * {c}_{2} ( n ) + {T}_{s e t}}{{k}_{{3}_{e s t}}}$$
$${k}_{{1}_{e s t}} = \frac{{V}_{i n} ( n ) - ( {M}_{i n t e g e r} ( n ) - 1 ) * {V}_{d c}}{{L}_{g}}$$
$${k}_{{2}_{e s t}} = \frac{- {M}_{i n t e g e r} ( n ) * {V}_{d c}}{{L}_{g}}$$
$${k}_{{3}_{e s t}} = \frac{{V}_{i n} ( n ) - ( {M}_{i n t e g e r} ( n ) + 1 ) * {V}_{d c}}{{L}_{g}}$$
$${T}_{s \_ est} ( n ) = {t}_{1 \_ est} ( n ) + {t}_{2 \_ est} ( n ) + {t}_{3 \_ est} ( n )$$
wherein t_{1_est}(n) is an estimated duration for a lower switch of the second power module being turned on during the current switching cycle, t_{2_est}(n) is an estimated duration for a lower switch of the first power module being turned on and the lower switch of the second power module being turned off during the current switching cycle, t_{3_est}(n) is an estimated duration for the lower switch of the first power module being turned off during the current switching cycle, Tₛ(n−1) is a duration for a previous switching cycle, Dₛ₂₁ is a duty cycle of an upper switch of the second power module, Dₛ₁₁ is a duty cycle of an upper switch of the first power module, i₀(n) is a sampled value of a minimum current flowing through the first inductor during the current switching cycle, Iₛₑₜ is an absolute value of a minimum current flowing through the first inductor that enables zero voltage conduction of the upper switches and the lower switches, k_{1_est} is a slope of the current flowing through the first inductor during t_{1_est}(n), k_{2_est} is a slope of the current flowing through the first inductor during t_{2_est}(n), K_{3_est} is a slope of the current flowing through the first inductor during t_{3_est}(n), Vᵢₙ(n) is a magnitude of the first voltage during the current switching cycle, V_{dc} is a magnitude of the second voltage, L_{g} is an inductance of the first inductor, and T_{s_est}(n) is an estimated duration for the current switching cycle.

28. The cascaded system according to claim 27, wherein the control unit is further configured to:
limit the estimated duration for the current switching cycle according to a preset highest frequency and a preset lowest frequency, to obtain a duration for the current switching cycle.
